(19) United States
(12) Patent Application Publication
(10) Pub. No.: US 2007/0277675 A1
(43) Pub. Date: Dec. 6, 2007

(54) FOOD HEATING SYSTEM

(76) Inventor: Charles P. Hickey, Cheyenne, WY (US)

Correspondence Address: BOYLE FREDRICKSON S.C., 840 North Plankinton Avenue, MILWAUKEE, WI, 53203, US

(21) Appl. No.: 11/755,918

(22) Filed: May 31, 2007

Related U.S. Application Data
(60) Provisional application No. 60/810,409, filed on Jun. 2, 2006.

(51) Int. Cl. A23L 1/00

(52) U.S. Cl. 99/275

(57) ABSTRACT

A device for heating a food item therein is provided, which includes a spout disposed on the exterior of the device through which a food item can be introduced into and dispensed from the device. The spout is selectively covered by a cover when in use to hold the food item within the device while being heated, and the cover can be removed to enable a food container to be engaged with the spout such that the food item can be dispensed from the device into the food container. Additionally, the device can include a number of compartments within the device, one of which can be accessed utilizing a recloseable seal on the device to position a second food item for heating within the device. The volume of the interior space of the device is formed to urge the food item positioned therein to completely surround a temperature-changing element positioned within the device, such that the entire element is insulated by the food item from the exterior of the device when heating or cooling the food item.

### CROSS-REFERENCE TO RELATED APPLICATIONS

This application claims priority under 35 U.S.C. § 119 from U.S. Provisional Patent Application Ser. No. 60/810,409, filed Jun. 2, 2006, the entirety of which is incorporated herein by reference.

### FIELD OF THE INVENTION

The present invention relates to devices for heating or cooling food products, and more specifically to a device for receiving, heating or cooling, and dispensing a food product.

### BACKGROUND OF THE INVENTION

To heat or cool food products, a number of different devices have been developed by which a food product can be heated or cooled to the point at which the food may be consumed by an individual. A number of these devices include heating or cooling elements positioned within the device that provide a heat or cooling source for altering the temperature of the food to the necessary temperature.

However, for a variety of devices of this type, especially those formed of flexible materials, such as thermoplastic materials, when devices of this type are used, it is difficult to place the items of food to be heated or cooled into these devices and to subsequently remove these heated or cooled food items from the devices. Additionally, the heating or cooling elements utilized in these devices often insufficiently heat or cool, or over heat or cool the food item placed in the device. In these situations, the amount of food placed in the device is either too great or too small to accommodate the entirety of the heating or cooling energy supplied by the device, or the food is positioned within the device in a location where only a portion of the energy from the device is directed into the food, with the remainder directed outwardly from the device.

Therefore, it is desirable to develop a device for heating a food item which provides the capability for easily introducing a food item into the device for heating, and subsequently removing the food item from the device for consumption after heating. The device should also be designed to hold a predetermined amount of a food item and to properly position the food item with respect to the device to ensure efficient heating of the food within the device.

### SUMMARY OF THE INVENTION

According to a first aspect of the present invention, a device for heating a food item is provided that is formed of a flexible thermoplastic material and within which is disposed a heating or cooling, or temperature-changing element capable of supplying the necessary heating or cooling energy to alter the temperature of the food item within the device. The device also includes an opening in the device that allows for the food items to be introduced into a device for contact with the temperature-changing element. This element of the device can take the form of threaded collar surrounding the opening in the device that can be enclosed by a cap when not in use. When the device is to be utilized to change the temperature of a food item, the cap is removed and a separate container holding the food item can be engaged with the collar in order to quickly and easily dispense the food item into the device. After the temperature of the food item has been properly altered by the temperature-changing element, the separate container can be reattached to the collar, and the device can be oriented to allow the food item to flow back into the container for easy consumption by an individual.

According to another aspect of the present invention, the opening in the device can be formed of a releasable closure that allows for the entire container holding the food item to be positioned within the device such that the temperature of both the food container and the food item are altered by the temperature-changing element in the device. In this version of the invention, the food item is positioned in thermal contact with, but spaced from the temperature-changing element. Further, the threaded collar can also be secured to the device with the resealable closure, such that the food item container and another food item dispensed into the device through the collar can be affected by the temperature-changing element simultaneously.

According to still another aspect of the present invention, the size of the device including the temperature-changing element is selected to completely enclose the temperature-changing element in a manner that restricts the available space around the element. This restriction in space within the device forces the food item positioned within the device around the entirety of the temperature-changing element to allow the entire amount of energy created by the element to affect the temperature of the food item. This also provides the device with the ability to maintain all of the energy created by the temperature-changing element within the device, as opposed to allowing some of the energy to escape the device, and potentially affecting or injuring an individual handling the device.

Numerous other aspects, features, and advantages of the present invention will be made apparent from the following detailed description taken together with the drawing figures.

### BRIEF DESCRIPTION OF THE DRAWINGS

The drawings illustrate the best mode currently contemplated as practicing the present invention.

In the drawings:

FIG. 1 is an isometric view of the food item heating device constructed according to the present invention;

FIG. 2 is a second embodiment of the device of FIG. 1;

FIG. 3 is a third embodiment of the device of FIG. 1;

FIG. 4 is a front plan view of a manipulating ring mounted to the device of FIG. 3;

FIG. 5 is a front plan view of a manipulator utilized with the device of FIG. 3;

FIG. 6 is a perspective view of a fourth embodiment of the device of FIG. 1; and

FIG. 7 is a perspective view of a second embodiment of the cover of FIG. 1.

### DETAILED DESCRIPTION OF THE INVENTION

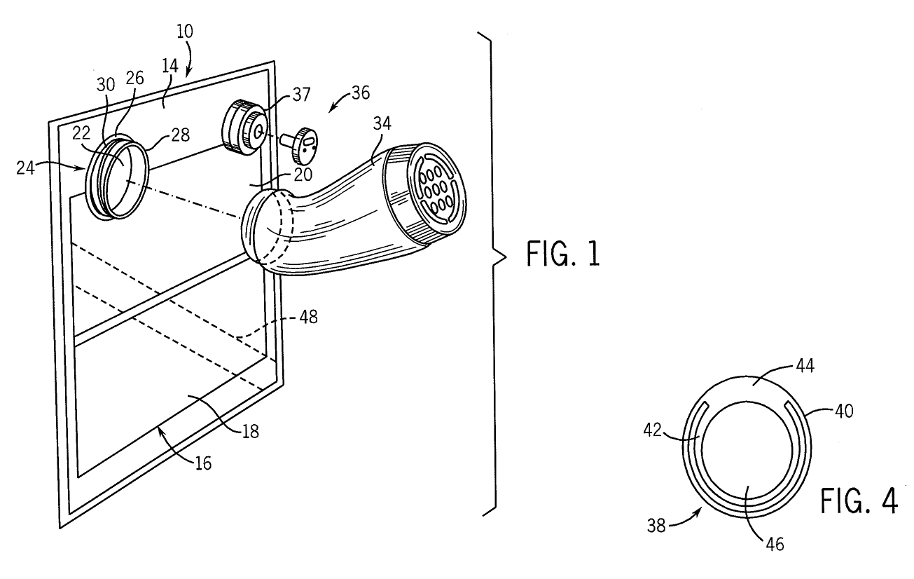

With reference now to the drawing figures in which like reference numerals designate like parts throughout the disclosure, a food heating or cooling device constructed according to the present invention is indicated generally at 10 in FIG. 1. The device 10 is formed of a suitable and flexible material, such as a thermoplastic material, that also can have any desired shape, but is preferably formed to be generally rectangular in shape. The device 10 takes the form of a pair of sheets 12 of materials of this type that are engaged with one another along the peripheral edges to define an interior space 14 therein. Within the interior space 14, a temperature-changing element 16 is disposed which, when activated, provides the necessary change in energy to warm or cool a food item positioned within the device 10. The temperature-changing element 16 can take any of various forms, but is preferably a chemical temperature-changing element, such as that described and claimed in co-pending and co-owned U.S. patent application Ser. No. 11/195,118, incorporated by reference herein in its entirety, including a pair of reagents (not shown) disposed in separate compartments 18, 20 that can be intermixed with one another in order to initiate an exothermic or endothermic reaction that can generate or remove heat from the device 10. In a particularly preferred construction, the reagents are selected to be a solid and liquid, with the liquid positioned within the lowermost compartment to achieve the most uniform temperature-changing reaction from the element 16. Also, the element 16 is preferably positioned immediately adjacent to the lowermost edge of the interior 14 to most efficiently change the temperature of the food items or products introduced into the device 10.

The device 10 further includes an opening 22 formed in one of the sheets 12 around which is positioned a spout 24 that extends outwardly from the sheet 12. The spout 24 includes a peripheral rim 26 secured to the sheet 12 in any suitable manner, such as by an adhesive, or by thermal or sonic welding, and a collar 28 extending outwardly from the rim 26. The collar 28 includes a thread 30 thereon that is matable with a cover 32 in order to close the opening 22 formed within the spout 24. When the cover 32 is removed, a food container 34, such as a baby bottle, can be inserted within or otherwise engaged with the collar 28 in order to allow a food item (not shown) held within the food container 34 to be dispensed from the container 34 directly into the device 10 through the spout 24. For example, the food item can the be heated by activating the temperature-changing element 16 in a known manner. Once the food item has been heated within the device 10 by the temperature-changing element 16, the food container 34 can be reengaged with the spout 24 such that the heated food item can be re-dispensed from the device 10 back into the food container 34 for easy consumption of the food item by an individual.

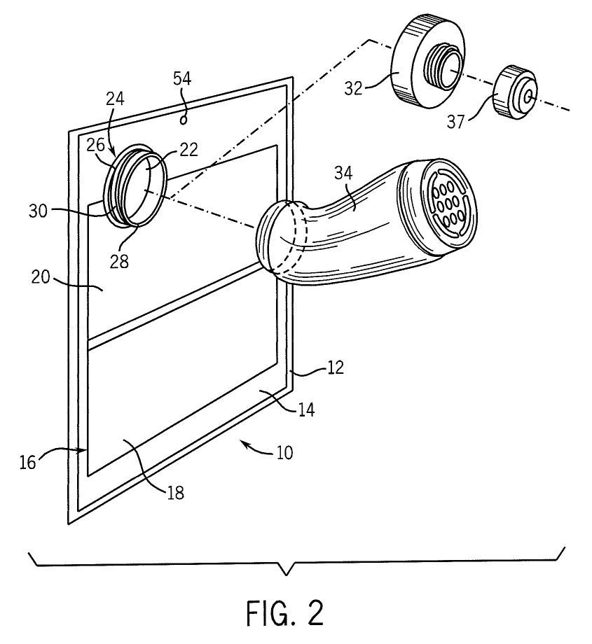

Referring now to FIGS. 1 and 2, during the heating or cooling of the food item within the device 10, the temperature of the food item can be monitored utilizing a thermal probe 36 engagable with a cap 37 that is secured to the device 10 on one of the sheets 12 in a suitable manner. The thermal probe 36 and cap 37 can have any desired form, but are preferably formed similarly to the device illustrated in co-pending and co-owned U.S. patent application Ser. No. 11/192,507, the entirety of which is incorporated herein by reference. The cap 37 to which the probe 36 is attached when in use thermal probe 36 can be spaced anywhere on the device 10 in order to provide an accurate reading of the temperature of the food item positioned within the device 10, such as spaced from the spout 24, as shown in FIG. 1, or an addition to the cover 32, as shown in FIG. 2.

In addition, the cover 32 can have the alternative form shown in FIG. 7. In this configuration, the cover 32 has an opening 100 formed directly in the cover 32 through which the food item can be dispensed from the device 10, instead of having to remove the entire cover 32. The opening 100 is selective openable using a plug 102 that is connected to the cover 32 by a hinge 104, preferably integrally formed between the plug 102 and the cover 32. Spaced from the opening 100 in the cover 32 is a probe interface 106 that is adapted to receive and retain the probe 36 thereon in the same manner as the cap 37.

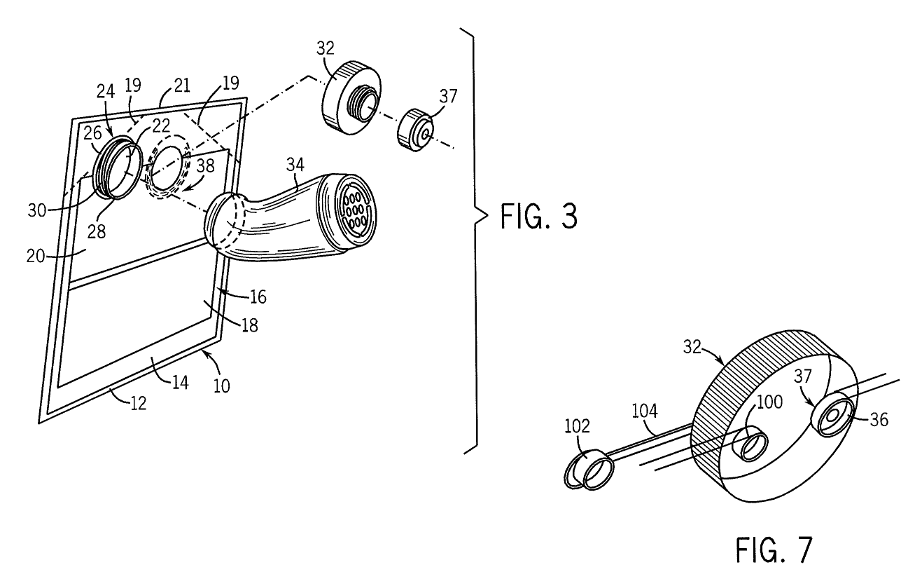

Referring now to FIGS. 3 and 4, in order to allow an individual to more easily manipulate the device 10 in order to dispense the heated or cooled food item from the device 10 into the food container 34, the device 10 may also include a handle 38 secured to the device 10 generally opposite the spout 24. The handle 38 can be formed of any suitable material, but is preferably formed of a thermoplastic material similar to that used to form the sheets 12 of the device 10, and includes an outer flange 40 that can be secured to the device 10 in any suitable manner, such as by an adhesive, or by thermal or sonic welding. In addition, the handle 38 also includes an inner flange 42 integrally connected to the outer flange 40 along a tab 44. The inner flange 42 is not secured to the device 10 such that the inner flange 42 can move with respect to the outer flange 40 and the device 10. The inner flange 42 defines an opening 46 therein that can be used by an individual to grasp the inner flange 42 and thereby manipulate the handle 38 and the device 10 when dispensing the food item from the device 10 into the food container 34, or vice versa.

Referring now to FIG. 1, as an alternative to the use of the handle 38 to assist and manipulate the device 10, the device 10 may also include a handling strip 48, best shown in FIG. 1, secured to opposed sides of the device 10, and able to be grasped by an individual to manipulate the device 10.

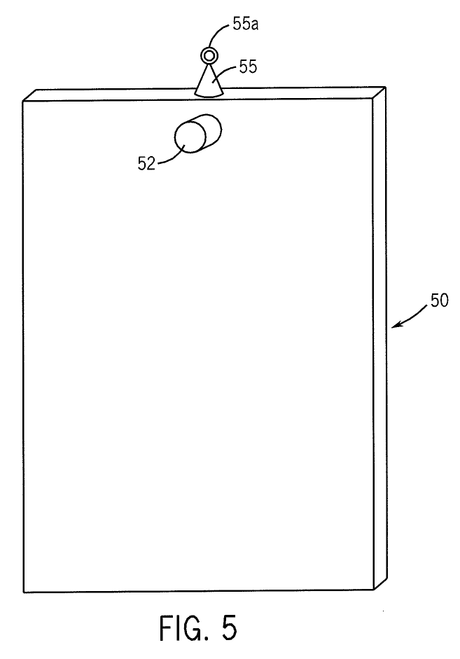

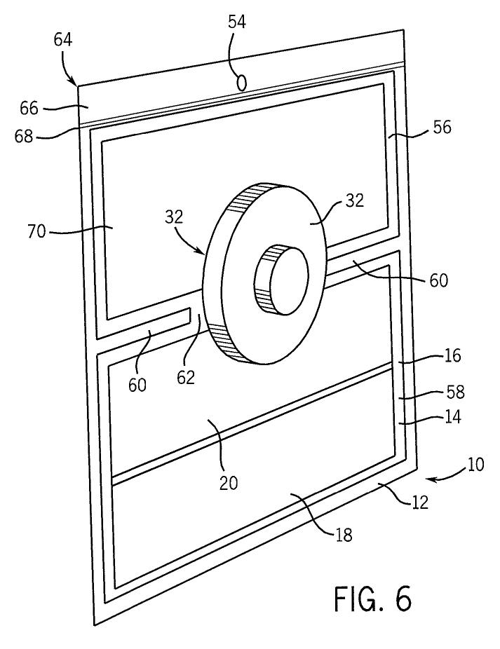

In still another alternative embodiment, the device 10 can include a separate handling support 50 releasably engagable with the device 10. The support 50, as shown in FIG. 5, is a generally rectangular member formed of a rigid material, such as a plastic material that includes a post 52 extending outwardly from one end thereof. The post 52 is insertable within a small aperture 54 (FIGS. 2 and 6) disposed in the device 10 adjacent the spout 24 in order to position the device 10 along the support 50, such that the device 10 can be grasped and manipulated along with the support 50. By grasping the device 10 and the support 50, the support 50 provides an amount of rigidity to the device 10, which enables the device 10 to be more easily manipulated when dispensing the heated food product from the device 10 into the food container 34.

As an alternative to the post 52, the support 50 can include a holding member 55 extending upwardly from one side edge of the support 50. In this configuration, the aperture 54 in the device 10 is positioned over the top of the holding member 55 such that gravity maintains the device 10 in the support 50 when used with the device 10. The holding member 55 can be formed to be conical in shape, which may include a ball 55a at its tip having a diameter slightly greater than the diameter of the aperture 54, and may also include a slot (not shown) or other engaging structure on the holding member 55 to enhance the engagement of the holding member 55 with the aperture 54 on the device 10.

In another embodiment of the device 10 best shown in FIG. 6, the interior space 14 of device 10 is separated into an upper compartment 56 and a lower compartment 58 by a pair inwardly extending side seals 60. The side seals 60 can be formed simultaneously with or separately from the peripheral seals extending around the sheets 12 forming the device 10 and extend partially across the device 10. Between the side seals 60 is defined an aperture 62 that allows fluid communication between the upper compartment 56 and the lower compartment 58. The lower compartment 58 encloses the temperature-changing element 16, such that the side seals 60 prevent the element 16 from moving out of the lower compartment 58 into the upper compartment 56. Additionally, the spout 24 and cover 32, with or without the thermal probe 36, are disposed on the device 10 approximately in alignment with the aperture 62.

The upper compartment 56 is accessible through a top end 64 of the device 10 through the use of a tearable portion 66 of the seal extending along the top end 64 that allows the sheets 12 to be separated at the top end 64 and expose an reclosable seal 68 disposed below and adjacent to the tearable portion 66 between the sheets 12. The reclosable seal 68 can be opened in order to allow a food container 70 to be positioned within the upper compartment 56 in a manner which allows the reclosable seal 68 to be re-closed once the food container 70 is positioned within the upper compartment 56. In this configuration, the cover 32 can be removed from the spout 24 and an amount of water or other suitable liquid can be introduced into the interior space 14 of the device 10. Once the cover is re-positioned on the spout 24, the temperature-changing element 16 can be activated in order to heat or cool the water disposed within the device 10. Once the water has reached the desired temperature, the device 10 can be re-oriented in order to urge the heated or cooled water out of the lower compartment 58, through the aperture 62 and into the upper compartment 56, such that the heated or cooled water surrounds the food container 70 and operates to heat or cool the food container 70 and the food item contained therein to the desired temperature. Once the food container 70 has reached the desired temperature, as measured by the thermal probe 36, the device 10 can be again re-oriented to allow the water to flow through the aperture 62 back into the lower compartment 58 and away from the food container 70. The seal 68 can then be reopened and the food container 70 can be removed for consumption of the food item contained therein.

Also, the device 10 can optionally include a separate bag (not shown), preferably formed of an insulating, non-woven material, that can be positioned around the lower end of the device 10 adjacent the temperature-changing element 16. The bag operates to insulate the device 10 from the hand of an individual holding the device 10 and the bag, such that the temperature achieved by the temperature-changing element 16 within the device 10 that is transmitted to the food item does not warm or cool the individual's hand.

Furthermore, instead of water being utilized as the heat transfer medium between the heating element 16 in the lower compartment 58 and the food container 70 in the upper compartment 56, another food item, such as beverage to be warmed or cooled, including coffee or tea, can be introduced into the lower compartment 58 through the spout 24, as described with regard to the previous embodiments for the device 10. Thus, when a beverage is used in this manner, not only is the temperature of the food item contained within the food container 70 changed as desired, but the temperature of the beverage is simultaneously changed as well such that two food items can be simultaneously prepared utilizing the device 10. To assist in manipulating the device 10 when dispensing the beverage or other fluid from within the device 10, the device 10 also includes the aperture 54 engagable with the post 52 or holding element 55 of the support 50 adjacent the recloseable seal 68 to allow the support 50 to be utilized with the device 10 having this configuration.

Further, in each of the above-described embodiments of the device 10, the interior space 14 of the device 10 is dimensioned such that the amount of the fluid or food item to be heated or cooled in the device 10 using the temperature-changing element 16 closely conforms to the volume of the interior space 14. In this manner, the food item is generally evenly positioned and maintained around the entire temperature-changing element 16, such that no portion of the element 16 can be directly contacted through the exterior of the device 10. Thus, an individual can easily manually hold the device 10, even thought the reaction occurring within the temperature-changing element 16 when used to heat a food product can reach temperatures of over two hundred degrees Fahrenheit (200° F.).

This function is provided by the device 10 through the dimensions of the interior space 14 of the device 10 in conjunction with or separately from a pair of opposed angled corners 19 that can be formed adjacent the top end 21 of the device 10. More particularly, the device 10 can be formed in any number of sizes in order to accommodate a known volume of a food item therein. The volume of the interior space 14 is selected to hold the volume of the food item and the volume of the temperature-changing element 16 in a manner that effectively requires that the food item be dispersed generally evenly about the entire periphery of the temperature-changing element 16. Thus, the food item forms a type of protective sheath extending around the entire temperature-changing element 16 so that the element 16 cannot be exposed within the device 10 when the food item is present. In a preferred embodiment, the dimensions of the interior space 14 and the temperature-changing element are selected to enable the food item or fluid positioned in the space 14 around the element 16 to form a layer around the element 16 to insulate the element 16 from the exterior of the device 10. Preferably, this layer is at least 1/16 of an inch, but can be up to ¾ of an inch or larger.

In addition, the amounts of each of the reagents utilized in the temperature-changing element 16 to create the heating or cooling reaction can be selected to provide or remove the desired amount of energy from the particular volume of the food item to be placed within the interior space 14 of the device 10.

In concert with the size of the interior space 14 and reagent amounts, one or more angled corners 19 can be formed on the device 10 can prevent any of the food item that is introduced into the device 10 from being positioned far enough away from the temperature-changing element 16 to expose a portion of the element 16. Each of the corners 19 is preferably formed as a heat seal across the device 10 to close off portions of the interior space 14 in the device 10, thereby restricting the volume of the interior space 14 and ensuring that all of the food item or fluid positioned in the device 10 surrounds the element 16 and is adequately heated or cooled by the element 16.

Additionally, the device 10, including the thermal probe 36, the support 50, and the food containers 34 and 70 can be included in a kit or separate container (not shown) such that all of the components for the device 10 and the food items can be contained in a single package, such as for retail sale as an individual meal.

Various alternatives are contemplated as being within the scope of the following claims particularly pointing out and distinctly claiming the subject matter regarded as the invention.

What is claimed is:

1. A device for heating a food item comprising:
a) a pair of sheets of flexible material secured to one another to define an interior space therebetween;
b) a temperature-changing element disposed within the interior space; and
c) a spout secured to one of the pair of flexible sheets that allows for the introduction and dispensing of a food item into and out of the interior space.

2. The device of claim 1 further comprising a cover releasably securable to the spout.

3. The device of claim 2 wherein the cover includes a thermal probe capable of measuring the temperature of the food item within the device.

4. The device of claim 3 wherein the cover includes an opening through which the food item can be dispensed.

5. The device of claim 4 wherein the opening is selectively openable by a plug operably connected to the cover and removably insertable within the opening.

6. The device of claim 1 further comprising a food container releasably connectable to the spout to introduce the food item into and receive the food item from the device.

7. The device of claim 1 wherein the interior space is dimensioned to have a volume that closely conforms to a volume of the temperature-changing element positioned within the interior space.

8. The device of claim 7 wherein the volume of the interior space is adapted to enable a food item positioned therein to surround the temperature-changing element.

9. The device of claim 7 wherein the volume of the interior space defines an insulating gap between the flexible material sheets and the temperature-changing element.

10. The device of claim 7 wherein the volume of the interior space is at least partially defined by at least one corner seal formed between the pair of sheets of flexible material.

11. The device of claim 1 wherein the interior space includes a first compartment and a second compartment separated by at least one panel seal.

12. The device of claim 11 wherein the temperature-changing element is disposed within the one of the first or second compartments.

13. The device of claim 12 wherein the volume of the first or second compartment is adapted to enable a fluid positioned therein to surround the temperature-changing element.

14. The device of claim 11 further comprising a recloseable seal adjacent one of the compartments to enable a second food item to be positioned within the interior space of the device.

15. The device of claim 14 wherein the first compartment is in fluid communication with the second compartment through an aperture defined by the at least on panel seal.

16. The device of claim 1 further comprising a support member operably connectable to the device to assist in the manipulation of the device when dispensing the food item from the device.

17. The device of claim 16 wherein the support member is formed of a strip of flexible material secured between opposed sides of the device.

18. The device of claim 16 wherein the support member is a rigid panel including a support post extending outwardly from the panel and releasably engagable with an aperture in the device.

19. The device of claim 18 wherein the support post is conical in shape.

20. The device of claim 19 wherein the support post includes a retaining ball disposed on the support post opposite the support panel.
